(19) United States
(12) Patent Application Publication
(10) Pub. No.: US 2007/0228182 A1
(43) Pub. Date: Oct. 4, 2007

(54) Thermostat with single button access to a menu of commonly used functions

(75) Inventors: Phillip Ryan Wagner, Baltimore, OH (US); Kathrin Bohn Stiles, Columbus, OH (US); John Gilman Chapman JR., Delaware, OH (US); Joseph P. Rao, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/394,582

(22) Filed: Mar. 31, 2006

(51) Int. Cl. G05D 23/00

(52) U.S. Cl. 236/94

(57) ABSTRACT

A thermostat permitting a user to easily access the most commonly used thermostat settings is provided. The thermostat includes a user interface display and a single menu or favorites (FAV) button. A top level menu is displayed on the user interface display when the FAV button is depressed. The top level menu includes a listing of the most commonly used thermostat settings on a single screen. As such, the thermostat user is permitted to easily select one of the commonly used thermostat settings without having to navigate through various different menus or screens. The thermostat also includes a digital version of the user's manual stored therein. This manual may be displayed on the user interface screen. A link to the manual may be provided on the single screen along with the listing of the most commonly used thermostat settings.

### FIELD OF THE INVENTION

This invention generally relates to heating, ventilating and air conditioning (HVAC) systems and, more particularly, to thermostats employed in those systems.

### BACKGROUND OF THE INVENTION

Most existing structures (e.g., residential dwellings, office buildings, etc.) are equipped with a thermostat for controlling a heating, ventilating and air conditioning (HVAC) system. The thermostat instructs the HVAC system such that the temperature and humidity within the structures are well regulated.

Traditionally, the thermostat was a fairly simple electromechanical device. However, advances in control electronics have allowed the development of new, digital thermostats that may be programmed by a user to control the heating and cooling equipment in a much more energy efficient manner than the older electromechanical devices. These modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure.

Unfortunately, many of the digital thermostats require that numerous menus be navigated and numerous selections be made in order to change even the most basic of thermostat settings. For example, to change from a heating mode to a cooling mode on a conventional thermostat, a thermostat user first depresses a “menu” button to display a partial list of menu options. If the partial list fails to contain a “mode selection” option, the user scrolls through the additional menu options until the mode selection option is revealed. In some cases, scrolling in this manner is performed by repeatedly depressing a “directional” button.

Once the mode selection option is displayed and highlighted, the user again depresses the menu button to select the mode selection option. When the mode selection option is chosen in this manner, the user is presented with a partial list of modes. If the partial list fails to contain a “heat” mode, the user scrolls through the additional modes until the heat mode is revealed. Again, the scrolling might very well involve repeatedly depressing the directional button. Once the heat mode is displayed and highlighted, the user again depresses the menu button and, finally, the heat mode is selected.

From the above example, it is readily apparent that changing even the most basic and often used functions offered by the conventional thermostat can be a frustrating and time-consuming endeavor. To make matters worse, if the menu system is extensive or particularly detailed, the thermostat user may have to stumble through a maze of different menus and submenus to find and modify a simple setting. While such menus may be described in the thermostat's user's manual, many consumers do not keep track of such user's manuals, lose them, or otherwise cannot access them for such description.

There exists, therefore, a need in the art for a thermostat that permits a user to quickly and conveniently access the most commonly or frequently changed settings. There further exists a need in the art for a user's manual that may more easily be located and utilized when a user has a question regarding operation of the thermostat The invention provides such a thermostat and user's manual. These and other advantages of the invention, as well as additional inventive features, will be apparent from the description of the invention provided herein.

### BRIEF SUMMARY OF THE INVENTION

In view of the above, an embodiment of the present invention provides a new and improved thermostat that overcomes one or more of the above described and other problems existing in the art. More particularly, an embodiment of the present invention provides a new and improved thermostat that permits a user to quickly and conveniently access the most commonly used settings on the thermostat. Still further, an embodiment of the present invention provides a new and improved thermostat that also allows access to the thermostat's user's manual without requiring the user to maintain a copy of the user's manual.

In one embodiment of the present invention, the thermostat utilizes a single button to provide the user quick and convenient access the most commonly used settings on the thermostat. Upon depressing the single button, a list of the most commonly used settings is displayed. Because the thermostat is programmable, the thermostat user can change the most commonly used settings to his or her liking. Also, the thermostat is able to “learn” the settings that are most frequently used and periodically automatically update the most commonly used settings based on the most frequently used settings that have been learned. The most commonly used settings are presented to the thermostat user in a conversational language form instead of a cryptic and abbreviated form.

In another embodiment of the present invention, the thermostat incorporates a user's manual and/or operating instructions in plain text or image/icon based format encoded digitally within the thermostat itself. The thermostat incorporates a display and navigation means for the manual by which the user can access and navigate through the manual. In a preferred embodiment, a dot matrix display is utilized to present the information. Scroll bars and navigation soft keys are used to navigate paginated material. In an alternate embodiment, a touch screen interface is provided to simplify the navigational aspects as well as providing contextual links within the displayed material. Access to the manual is provided in one embodiment through the single button introduced above.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front view of an exemplary embodiment of a thermostat constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

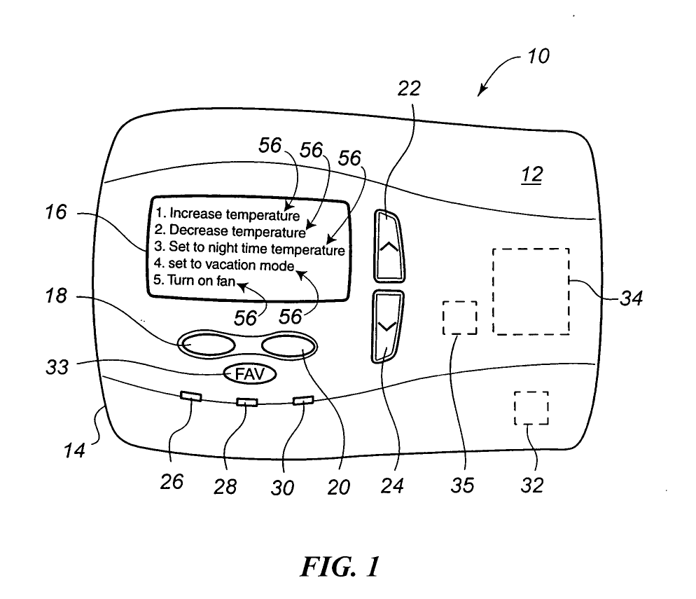

Referring to FIG. 1, an embodiment of a thermostat 10 constructed in accordance with the teachings of the present invention is illustrated. As will be explained in detail below, the thermostat 10 permits a user to quickly, conveniently, and easily select commonly used thermostat settings and/or navigate through available thermostat settings. In a further embodiment of the present invention, the thermostat 10 also provides the user with access to the thermostat's user's manual in digital form.

The front face 12 of the thermostat 10 exhibits a housing 14, a display 16, soft keys 18, 20, adjustment keys 22, 24, operating mode visual indicators 26, 28, 30, an internal temperature sensor 32, a top level menu or favorites (FAV) button 33, control logic 34, and a memory 35. As is conventional, the thermostat 10 is operable to control the heating, ventilating and air conditioning (HVAC) system to regulate the environmental conditions within a dwelling or structure.

The display 16 displays various programming, system, and ambient information regarding the operation of the thermostat 10, the HVAC system 52, environmental conditions within the structure, and the like. The display 16 is also able to present to a thermostat user all of the available settings of that particular model of the thermostat 10. The available settings are often numerous, especially if the thermostat 10 is rather advanced, and are organized into a variety of menus and submenus. The display 16 can illustrate numbers, text, icons, and the like. The displayed items can be static or dynamic and may be monochrome or multi-color. The display 16 may take various forms well known in the art. For example, the display 16 can be a dot matrix LCD display. In one embodiment, the display 16 is a touch screen display.

Using the display 16, the consumer may activate various programming and control functions via the pair of soft keys 18, 20. The functionality executed by these soft keys 18, 20 varies depending upon the program state in which the thermostat 10 is at the time one of the soft keys 18, 20 is depressed. The particular functionality that will be instituted upon selection of one of the soft keys 18, 20 is displayed in a portion of the display 16 proximate the key 20, 22 which will institute that function. That is, the function that will be instituted upon selection of soft key 18 will be located generally in the lower left hand portion of the display 16 while the functionality that will be instituted by selection of soft key 20 will be located generally in the lower right hand portion of user display 16. These functional indicators may change depending on the program state and mode in which the thermostat is currently operating.

In addition to the soft keys 18, 20, this embodiment of the thermostat 10 also includes adjustment keys 22, 24. These adjustment keys 22, 24 may serve to adjust a currently selected parameter up or down, such as in the case of setting the control temperature at which the thermostat will maintain the ambient environment. Additionally, these keys 22, 24 may scroll through the available data for a selected parameter, such as scrolling through alphanumeric data that may be selected for a given parameter. These keys 22, 24 may also function as soft keys depending on the programmatic state in which the thermostat is operating. When this functionality is provided, the function that will be instituted by selection of key 22 will be provided generally in the upper right hand corner of display 16, while the functionality that will be instituted by selection of key 24 will be displayed generally in the lower right hand corner of the display 16. In addition to the above, other use input means, such as an alphanumeric keypad, user rotatable knob, a touch screen, and the like, may be utilized instead of or in addition to the buttons 18-24 illustrated in the embodiment of FIG. 1.

Employing one or a combination of the soft keys 18, 20 and the adjustment keys 22, 24, the thermostat user is able to view and navigate through each of the menus and submenus that include the various settings, programs, modes, and functions for the thermostat 10. With enough skill, the thermostat user is able to drill down through the menu structure to change a desired setting. Again, if the model of thermostat 10 is rather sophisticated, the number of menus and submenus can be large.

The indicators 26-30 provide a visual indication of the current operating mode of the thermostat 10 and/or the HVAC system 52. In the embodiment illustrated in FIG. 1, indicator 26 illuminates while the thermostat 10 is operating in the cooling mode. In the cooling mode, the thermostat 10 is instructing the HVAC system 52 to operate an air conditioning system 66 as shown in FIG. 3 to cool the structure. Indicator 30 will illuminate while the thermostat 10 is operating in the heating mode. In the heating mode, the thermostat 10 is instructing the HVAC system 52 to run a heating system 68 or furnace as shown in FIG. 3 to heat the structure. Finally, the indicator 28 will illuminate while the thermostat 10 is operating in the fan only mode. In the fan only mode, the thermostat 10 is instructing the HVAC system 52 to circulate air through the structure using a fan 70 as shown in FIG. 3 within the HVAC system. Depending on the particular application, the indicator 28 may illuminate whenever the fan 70 is running or may illuminate only when the fan is selected to run continuously.

An internal temperature sensor 32 may be employed to sense an ambient temperature within the structure proximate the sensor. Based on the temperature sensed by the internal temperature sensor 32, the thermostat 10 is able to instruct the HVAC system 52 to ensure that the occupant of the structure is kept comfortable and/or the HVAC system is operated efficiently. The thermostat 10 can also be operably coupled to, and in communication with, an external or remote temperature sensor(s) (not shown). The remote temperature sensor is remotely located relative to the internal temperature sensor 32 in the thermostat 10 and provides an indication of the temperature at a different location within the structure. Using one or more remote temperature sensors, the thermostat 10 is able to more precisely control temperatures within the structure.

The top level menu or favorites (FAV) button 33 is generally a depressible key or other device capable of being manipulated by a user. The FAV button 33 is operably coupled to the display 16, typically via the control logic 34. When the FAV button 33 is depressed or otherwise actuated, the thermostat 10 generates a top level menu 54 that includes only the most commonly used thermostat settings 56 (i.e., functions, modes, etc.). As illustrated in FIG. 1, by way of example and not limitation, five of the most commonly used thermostat settings 56 (numbered one through five) are shown. Even though five commonly used settings 56 are shown, more or fewer of could easily be exhibited.

Because only the most commonly used thermostat settings 56 are displayed, the thermostat user is not required to navigate through the various menus and submenus that list or display include all of the available settings of the thermostat 10. As such, the user is able to quickly and easily select from those settings that are most commonly changed, updated, and/or used.

The thermostat user is able to choose from the relatively few commonly used settings 56 on the top level menu 54 in a variety of ways. For example, the thermostat user can use either or both of the soft keys 18, 20 and the adjustment keys 22, 24. Also, in an embodiment where the display 16 is a touch screen display, the user can simply take advantage of the touch screen by touching the area of the display proximate the desired commonly used setting.

As those skilled in the art and thermostat users alike will recognize, the thermostat 10 permits the most commonly used settings 56 to be accessed and updated with a minimum of actions. In the illustrated embodiment, when the thermostat user wants to, for example, set the thermostat 10 to a night time temperature mode, the user simply depresses the FAV button 33, depresses the adjustment key 24 twice, and then depresses one of the soft keys 18, 20. In a mere four steps, the thermostat user has changed the desired commonly used mode.

If, for example, the display 16 is a touch screen display, the procedure in the above-noted example is even more brief. The user simply depresses the FAV button 33 and then touches the area of the display 16 proximate the “3 Set night time temperature” phrase. In this embodiment, only two steps are needed for the user to change the thermostat 10 to the commonly used mode. Whether the number of steps is four, two, or some other small number, the thermostat 10 clearly permits the most commonly used settings 56 to be accessed and changed without the user having to navigate the plethora of menus and submenus.

The list of most commonly used settings 56 in the top level menu 54 can be fixed in one embodiment, and can be changed automatically and/or manually in alternate embodiments. For example, the user, an installer, a retailer, and/or a manufacturer can program the thermostat to generate those commonly used modes that are most desirable. Therefore, the user is able to customize the list of commonly used settings 56 as desired. In other embodiments, as will be described more fully below, the thermostat 10 itself adjusts the listing of features or functions based on learned preferences of the user.

Specifically, in addition to performing a host of typical thermostatic control functions as well known to those skilled in the art, the control logic 34 is configured to “learn” which settings made available by the thermostat 10 are the most frequently used. In other words, if the thermostat user frequently sets the thermostat 10 to a vacation mode, the control logic 34 recognizes this situation and can update the commonly used settings 56 in the top level menu 54 based upon the frequently changed and/or viewed settings. Therefore, in one embodiment the list of commonly used settings 56 in the top level menu 54 are dynamic and subjected to modification as the thermostat 10 is used.

In this embodiment, the control logic 34 periodically and/or automatically updates the top level menu 54 to reflect those frequently used thermostat settings that have been learned. By updating the top level menu 54 in such a fashion, the top level menu displays the most commonly used settings on a real time basis. One benefit of this feature is that the most commonly used settings 56 in the top level menu 54 are specifically tailored to the particular thermostat user.

The top level menu or favorites button 33 can be marked with an identifying indicia such as, for example, the word favorite, common, or an abbreviations thereof such as FAV illustrated in FIG. 1. In addition, the top level menu button 33 can be back lit or otherwise illuminated to stand out in the dark. As a result, the FAV button 33 may be quickly and easily identified and accessed by the user.

In the illustrated embodiment, the top level menu 54 is in the form of a list of commonly used settings 56. The list includes conversational language as opposed to acronyms, mnemonics, short descriptors, or cryptic labels. Therefore, the thermostat user is not required to decipher any setting commands. In one embodiment, the commonly used thermostat settings 56 are represented in the form of recognizable icons arranged upon the screen. For example, an icon in the shape of a flame is used to signify a setting for increasing temperature while another icon in the shape of a snowflake is used to signify decreasing temperature.

The control logic 34 is generally an electronic device such as, for example, a microprocessor, microcontroller, programmable logic device, integrated circuit, and the like. The control logic 34 typically employs software and/or firmware to operate the thermostat 10. The control logic 34 and the memory 35 are operably coupled to each other. Therefore, the control logic 34 is able to access information from, and store information in, the memory 35. In one embodiment, the memory 35 is a non-volatile memory that holds at least one of a digitized user's manual and digitized installation instructions. Each of these digital documents can be recalled by the thermostat user and generated on the display 16 (regardless of whether the thermostat 10 has been installed or not). By having a digital copy of these manuals, the need for printing and distributing costly paper manuals is reduced or eliminated. Further, the problem of the user losing the manual is eliminated. In one embodiment of the present invention, access to the user's manual is provided as one of the options illustrated on the top level menu 54 when the FAV button 33 is actuated. In other embodiments, it is accessed via the normal menu selection process.

In operation, when the thermostat user desires to change a commonly used thermostat setting, such as turning on the fan 70, the user depresses the FAV button 33. As a result, a top level menu 54 having only the most commonly used settings 56 is displayed on the display 16. The other settings that the thermostat 10 may offer are not shown on this top level menu 54. If the display 16 is a touch screen, the thermostat user simply touches the area of the display proximate the phrase “5 Turn on fan” and the fan 70 is activated. If the display 16 is not a touch screen, the adjustment key 24 is depressed twice or held for a certain period of time until the desired phrase in the stack of settings is selected. Alternatively, the adjustment key 22 can be depressed once to move through the stack of settings from up to down to highlight the desired phrase. In other words, the stack of settings is configured to provide a wrap around capability. When the fifth setting is highlighted, one of the soft keys 18, 20 or some other key or button is depressed or manipulated to select the fifth setting adjacent to the phrase “5 Turn on fan.”

In both of the above scenarios, the fan 70 is activated and begins operating to circulate air through the structure. Also, because the setting pertaining to activating the fan 70 was selected, that particular selection is considered by the control logic 34 and, perhaps, stored in memory 35. If the fan 70 has been activated enough times, the control logic 34 in one embodiment reorganizes the list within the top level menu 54 to move the “5 Turn on the fan” setting higher within the list. As particular settings are chosen more often, even those not presently in the top level menu 54, the control logic 34 is able to modify the top level menu to include the most frequently used settings within the most commonly used settings 56. In sum, the control logic 34 in one embodiment is continually rearranging and updating the top level menu 54 to ensure that the most commonly used settings included in the top level menu are truly the most commonly used settings each time the top level menu button 33 is used by the thermostat user.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended tenns (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat, comprising:
a user interface display; and
a favorites (FAV) button; and
wherein a top level menu is displayed on the user interface display when the FAV button is depressed, the top level menu including a listing of a plurality of most commonly used thermostat settings.

2. The thermostat of claim 1, wherein the most commonly used thermostat settings are updated to include frequently used thermostat settings.

3. The thermostat of claim 2, further comprising control logic, and wherein the control logic learns the frequently used thermostat settings based on user input.

4. The thermostat of claim 1, wherein the listing of the most commonly used thermostat settings is populated with settings selected by a user.

5. The thermostat of claim 1, wherein the list of the commonly used thermostat settings employs conversational language.

6. The thermostat of claim 1, wherein the listing of the most commonly used thermostat settings is in the form of a plurality of icons representing the most commonly used thermostat settings.

7. The thermostat of claim 1, wherein the display is a touch screen display, the touch screen display permitting at least one of the most commonly used thermostat settings to be selected by a user though touching thereof.

8. The thermostat of claim 1, wherein the display is a dot matrix liquid crystal display (LCD).

9. The thermostat of claim 1, wherein the thermostat further comprises means for selecting at least one of the most commonly used thermostat settings.

10. The thermostat of claim 1, wherein the thermostat further comprises a non-volatile memory, the memory storing at least one of a user's manual and a installation manual, and wherein the at least one of the user's manual and the installation manual may be displayed on the display upon user selection.

11. The thermostat of claim 10, wherein the listing of the most commonly use thermostat settings includes a selection to access the at least one of the user's manual and the installation manual.

12. The thermostat of claim 10, wherein the display is a touch screen display, the touch screen display permitting display and navigation of the at least one of the user's manual and the installation manual by a user though touching thereof.

13. A thermostat permitting a user to easily navigate through available thermostat settings, the thermostat comprising:
a user interface display; and
a single menu button; and
wherein a top level menu is displayed on the user interface display when the single menu button is selected, the top level menu including a subset of commonly used thermostat settings selected from available thermostat settings.

14. The thermostat of claim 13, wherein the commonly used thermostat settings are updated to include frequently used thermostat settings.

15. The thermostat of claim 14, further comprising control logic, and wherein the control logic learns the frequently used thermostat settings based on user input.

16. The thermostat of claim 14, wherein the commonly used thermostat settings are selected by a user.

17. The thermostat of claim 13, further comprises a non-volatile memory, the non-volatile memory storing information on operation of the thermostat, and wherein the information may be displayed on the display upon user selection.

18. A method of accessing commonly used settings within a programmable digital thermostat having numerous available settings available on different menus, comprising the steps of:
receiving a user input selection requesting the commonly used settings to be displayed; and
displaying the commonly used thermostat settings on a single screen.

19. The method of claim 18, further comprising the step of selecting individual settings from the numerous available settings to be included on the single screen.

20. The method of claim 18, further comprising the steps of:
monitoring user selections of the numerous available settings;
learning which of the numerous available settings are most frequently selected; and
updating the commonly used settings to include the settings that are most frequently selected.

21. The method of claim 18, wherein the step of displaying comprises the step of displaying the commonly used thermostat settings and a selection for a thermostat user's manual on a single screen, and further comprising the step of displaying the thermostat user's manual upon user selection thereof.
